(19) United States
(12) Patent Application Publication
(10) Pub. No.: US 2006/0034183 A1
(43) Pub. Date: Feb. 16, 2006

(54) Method for minimizing collision during data broadcasts in ad hoc networks

(76) Inventors: Zafer Sahinoglu, Somerville, MA (US); Gang Ding, West Lafayette, IN (US); Philip Orlik, Cambridge, MA (US)

Correspondence Address: Patent Department;Mitsubishi Electric Research Laboratories, Inc., 201 Broadway, Cambridge, MA, 02139, US

(21) Appl. No.: 10/918,512

(22) Filed: Aug. 13, 2004

(51) Int. Cl. H04L 1/00

(52) U.S. Cl. 370/252; 370/395.21; 370/519

(57) ABSTRACT

A method determines a delay for rebroadcasting a packet received in a node via a channel of a wireless network. After the packet is received, the node measures a quality of the channel of the network. A broadcast degree of the receiving node is determined, and a delay for rebroadcasting the packet is set as a function of the quality and the broadcast degree.

### FIELD OF THE INVENTION

This invention relates generally to wireless networks, and more particularly to collision avoidance during broadcasting.

### BACKGROUND OF THE INVENTION

To broadcast a packet throughout an entire wireless network of nodes, it may be necessary for some nodes to rebroadcast the packet if the nodes have a communication range that is less than a span of the entire network. This is called multi-hopping.

In one prior art method, every node in the network rebroadcasts a received packet exactly one time. However, that method causes a “broadcast storm problem.”

One method avoids collisions by having each node use a different delay before rebroadcasting the packet. Another method determines whether a packet needs to be rebroadcast at all using a probabilistic scheme based on the number of duplicated packets, Ni et al., “The Broadcast Storm Problem in a Mobile Ad Hoc Network,” MobiCom, August 1999.

Another method uses a delay selected from a random distribution, Williams et al., “Comparison of Broadcasting Techniques for Mobile Ad Hoc Networks,” MobiHoc, 2002.

Another method uses the random delay and a relative distance between a transmitter and receiver to determine whether or not to rebroadcast a packet, Tseng, et al., “Adaptive Approaches to Relieving Broadcast Storms in a Wireless Multi-hop Mobile Ad Hoc Network,” IEEE Trans. on Computers, 52(5): pp. 545-557, 2003.

If global network topology information is known, the problem of selecting the minimum number of rebroadcast nodes is NP-complete. However, the problem can be approximated with a constant ratio, if node position information is available, Lim, et al. “Flooding in Wireless Ad Hoc Networks,” Computer Communication Journal, 24(3-4), pp. 353-363, 2001.

Rebroadcasting policies can also be based on local network topology information, such as a list of 1-hop or 2-hop neighbors, Dai et al., “Performance Analysis of Broadcast Protocols in Ad Hoc Networks Based on Self-Pruning,” IEEE Trans. on Parallel and Distributed Systems, September 2004. Alternatively, a node can assign a subset of its neighbors to rebroadcast the packet, see, Lou et al., “Localized Broadcasting in Mobile Ad Hoc Networks Using Neighbor Designation,” Handbook of Mobile Computing, CRC Press, July 2003.

Energy efficiency in broadcast has been extensively studied. One method uses a centralized procedure, Cagalj et al., “Minimum-Energy Broadcast in All-Wireless Networks: NP-Completeness and Distribution Issues,” MobiCom, 2002. However, that is a NP-complete problem. Local procedures cannot approximate an optimal solution, Cartigny et al., “Localized Minimum-Energy Broadcasting in Ad-Hoc Networks,” InfoCom 2003.

Broadcast storm is also addressed in U.S. Pat. No. 5,636,345 issued to Valdevit on Jun. 3, 1997, U.S. Pat. No. 5,793,978 issued to Fowler on Aug. 11, 1998, U.S. Pat. No. 6,185,185 issued to Bass et al. on Feb. 6, 2001, and U.S. Pat. No. 6,256,312 issued to Joh on Jul. 3, 2001.

Therefore, there is a need for a rebroadcast policy that improves over the prior art.

### SUMMARY OF THE INVENTION

A method determines a delay for rebroadcasting a packet received in a node via a channel of a wireless network.

After the packet is received, the node measures a quality of the channel of the network.

A broadcast degree of the receiving node is determined, and a delay for rebroadcasting the packet is set as a function of the quality and the broadcast degree.

The node can also determine a tree degree, and only rebroadcast if the tree degree is greater than zero.

### BRIEF DESCRIPTION OF THE DRAWINGS

FIG. 1 is a block diagram of a method for delaying rebroadcasting of packets in a wireless network; and

FIG. 2 is a diagram of a procedure according to the invention.

### DETAILED DESCRIPTION OF THE PREFERRED EMBODIMENT

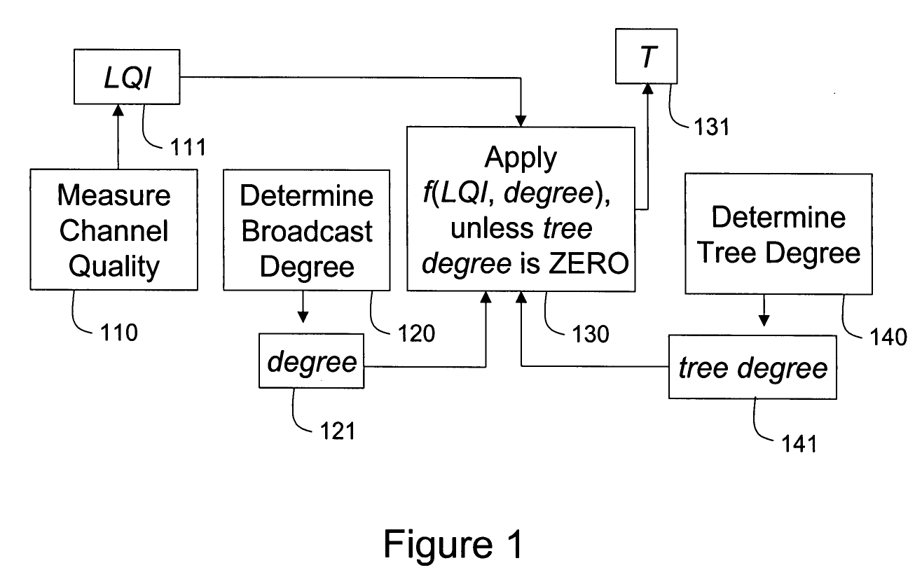

As shown in FIG. 1, the invention provides a method for determining a delay 131 for rebroadcasting packets in a wireless network of nodes. The method measures 110 a quality (LQI) 111 of a channel and determines 120 a broadcast degree 121 to determine 130 a delay T 131 before a particular node rebroadcasts a received packet. The method also determines 140 a tree degree 141. If the tree degree 141 is zero, the there is no broadcast.

Channel Quality

In networks designed according to the IEEE 802.15.4 standard, a channel or link quality index (LQI) can be estimated from a signal strength, a signal to noise ratio (SNR), or both in the case where it needs to be determined if packets are corrupted due to low signal strength or high signal strength subject to interference.

If the quality of the channel is relatively good, then the delay is relatively longer, and if the quality of the channel is relatively bad, then the delay is relatively shorter. The assumption here is that if the quality is relatively good, then the transmitting node is relatively close to the receiving node, and the broadcast ranges of the transmitting and receiving nodes overlap substantially. In this case, a rebroadcast is less likely to reach nodes that have not received the packet. However, if the quality is low, the ranges of the transmitting and receiving nodes have little overlap, and the rebroadcast is likely to reach a more nodes that have not yet received the packet.

Broadcast Degree

The broadcast degree is derived from a local topology of the network, i.e., a list of one-hop neighboring nodes. The broadcast degree is the number of neighboring nodes that have not received the packet to be rebroadcast.

The broadcast degree is determined from a list of neighboring nodes maintained by each node. The node list can be constructed by ‘eavesdropping’ on network traffic. In the ad hoc network according to the invention, addresses of the nodes are distributed hierarchically as the network is constructed. That is, each parent distributes a range of addresses to child nodes, and the child nodes redistribute portions of the range to their children, and so forth. Therefore, an eavesdropping node can ‘learn’ the hierarchy of the nodes that are within its broadcast range and construct the neighborhood list that indicates the hierarchy, i.e., the parent nodes and their children.

Now, if a particular node receives a packet from source node that is the parent of a destination node within broadcast range of the particular node, then a rebroadcast of the packet will not be useful with respect to the child node, because in all likelihood the child node will also have received the packets.

Therefore, the broadcast degree is the total number of nodes that have not received the packet. If the broadcast degree is relatively large, then the delay is relatively short and if the broadcast degree is small, then the delay should be long. This the invention favors an early rebroadcasting if that is likely to reach a large number of nodes that have not yet received the packet.

Tree Degree

The tree degree is the total number of tree neighbors of a node that are likely not to have received the packet. The tree degree initially includes the parent node and all sibling nodes of the node receiving the packet to be rebroadcast. Using ‘eavesdropping,’ a node can learn which of its tree neighbors are within broadcast range. Each time such a node is detected, the tree degree is decreased by one. When the tree degree reaches zero, that node does rebroadcast received packets.

Delay T

The delay T is expressed in a closed form function as
a. T=ƒ(α(LQI), β(broadcast degree)),
where α and β are weights, and the function satisfies

$$\frac{\partial f}{α . LQI} > 0 , \frac{\partial f}{β . broadcast degree} < 0.$$

One function that satisfies the above constraint is T=k. αLQI/β(broadcast degree), where k is a parameter to scale T to the appropriate time resolution. The LQI and broadcast degree are weighted to reflect their relative effectiveness in reducing the likelihood of collisions due to rebroadcasting packet. It should also be noted that nodes with tree degree=0 never rebroadcast. Also, during the waiting time T, if the tree degree becomes zero, nodes will not rebroadcast.

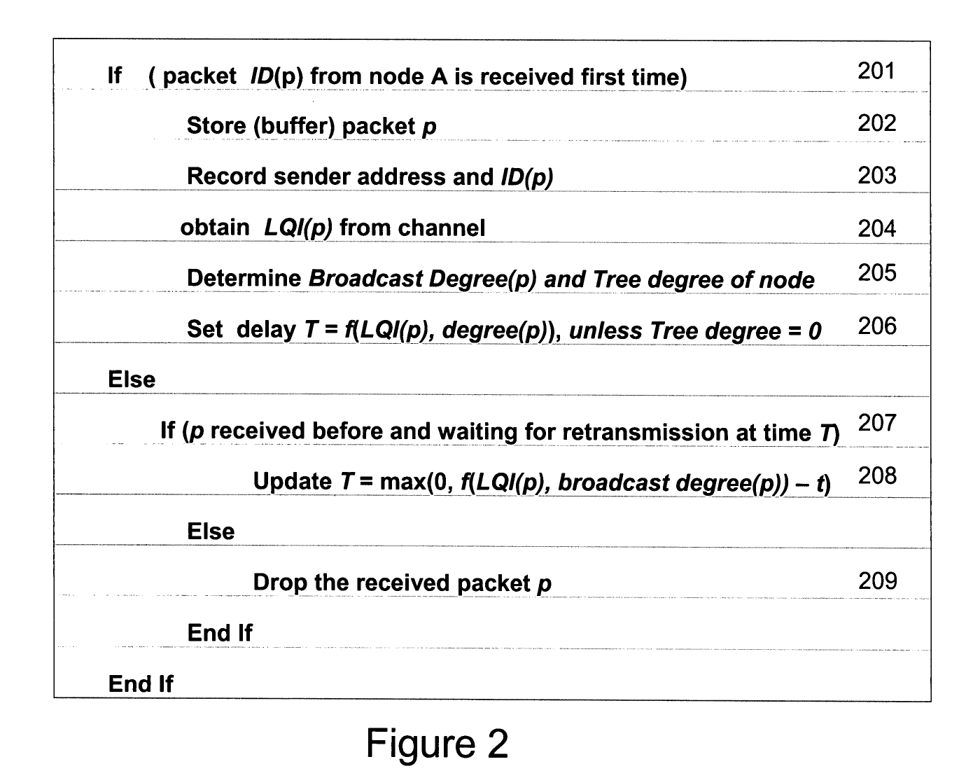

FIG. 2 shows pseudo code of a procedure that implements the method according the invention. If a packet p is received 201 for the first time, then store 202 the packet in a buffer, record 203 the sender ID, measure 204 channel quality (LQI), determine 205 the broadcast degree, and set 206 the delay T, unless the tree degree is zero. Else, if the packet was received 207 before, then update 208 the delay, else, drop 209 the packet.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for determining a delay for rebroadcasting a packet received in a node via a channel of a wireless network, comprising:
receiving a packet in a receiving node;
measuring a quality of a channel of a network in the receiving node;
determining a broadcast degree of the receiving node; and
setting a delay for rebroadcasting the packet as a function of the quality and the broadcast degree.

2. The method of claim 1, further comprising:
determining a tree degree of the receiving node; and
rebroadcasting the packet only if the tree degree is greater than zero.

3. The method of claim 1, further comprising:
estimating the quality from a signal strength of the received packet.

4. The method of claim 1, further comprising:
estimating the quality from a signal to noise ratio of the received packet.

5. The method of claim 1, further comprising:
estimating the quality from a signal strength and a signal to noise ratio of the received packet.

6. The method of claim 1, in which the delay is inversely proportional to the quality and directly proportional to the broadcast degree.

7. The method of claim 1, in which the broadcast degree is a number of neighboring nodes to the receiving node that have not received the packet.

8. The method of claim 1, in which the quality and broadcast degree are each weighted.

9. The method of claim 2, in which the tree degree is a total number of tree neighbors of the node that have not received the packet.

10. The method of claim 1, further comprising:
expressing the delay T in a closed form as
T=ƒ(α(LQI), β(broadcast degree)),
where α and β are weights, and which satisfy
$$\frac{\partial f}{α . LQI} > 0 , \frac{\partial f}{β . broadcast degree} < 0.$$

11. The method of claim 10, in which the function ƒ is
k. αLQI/β Degree, where k is a parameter to scale the delay T.
